(19) United States
(12) Patent Application Publication
(10) Pub. No.: US 2017/0310815 A1
(43) Pub. Date: Oct. 26, 2017

(54) METHOD AND APPARATUS FOR PROVISIONING SUBSCRIBER INFORMATION TO A DEPLOYABLE NETWORK IN A WIRELESS COMMUNICATION SYSTEM

(71) Applicant: MOTOROLA SOLUTIONS, INC, SCHAUMBURG, IL (US)

(72) Inventors: GABI OFIR, RESHON LETZION (IL); RONY GOTMAN, TEL AVIV-YAFFO (IL); GUY HOLTZMAN, TEL AVIV (IL); EITAN KOREN, RAANANA (IL); ITZHAK SHPERLING, BNEI-BRAK (IL)

(21) Appl. No.: 15/138,256

(22) Filed: Apr. 26, 2016

(51) Int. Cl. H04M 1/725; H04W 4/02

(52) U.S. Cl. CPC H04M 1/72572; H04W 4/021

(57) ABSTRACT

A method and apparatus for provisioning subscriber information to a deployable network in a wirelress communication system. One exemplary embodiment provides a method providing subscriber information to a deployable network including a deployable user subscription database. The method includes determining, by a controller, a location for the deployable network. The method further includes determining, by the controller, a geofence around the location. The method further includes identifying, by the controller, at least one mobile device that may be involved in responding to the incident. The method further includes determining, by the controller, authentication information required for the at least one mobile device to connect to the deployable network. The method further includes conveying, by the controller via a wireless data network, the authentication information to a deployable user subscription database.

### BACKGROUND OF THE INVENTION

Conventionally, public safety systems offer centralized services that reside at a central area and are available to public safety users in the field through a wireless wide area network (WWAN), such as a fixed long term evolution (LTE) infrastructure, serving a large geographic area such as a city or county. The fixed LTE infrastructure may include network equipment connected to, for example, cell sites, mobile switching offices and other communication assets of a service provider. Public safety systems are evolving such that first responders are equipped with mobile devices, in the form of handsets, laptops, etc., that have the capability of wirelessly networking together in a high-speed wireless local area network (WLAN) serving a much smaller geographic area, such as a city block. Exemplary services can include video services via a server, web services via a server, push-to-talk services, location services, and the like.

An incident area network (IAN) employing the LTE communication technology may be set up ad-hoc in an area where a connection to an existing fixed LTE infrastructure may be lost, unavailable (for example, because the incident area is remote), or because there is a need for an isolated (i.e., private) network within the covereage area of an existing fixed network. To enable emergency communications in such an area, a deployable LTE infrastructure may be temporarily dispatched to the IAN to provide temporary LTE coverage. The deployable LTE infrastructure may be provided in a mobile environment, for example, on a vehicle or a trailer. To maintain secure communications among the first responders in the incident area, the first responders' mobile devices must be able to authenticate to the deployable LTE infrastructure.

### BRIEF DESCRIPTION OF SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a wireless communication system in accordance with various embodiments of the present invention.

FIG. 2 is a block diagram of a mobile device of the communication system of FIG. 1 in accordance with an embodiment of the present invention.

FIG. 3 is a block diagram of a deployable network mobility and authentication device of the communication system of FIG. 1 in accordance with an embodiment of the present invention.

FIG. 4 is a block diagram of a deployable network user subscription database of the communication system of FIG. 1 in accordance with an embodiment of the present invention.

FIG. 5 is a block diagram of a fixed network controller of the communication system of FIG. 1 in accordance with an embodiment of the present invention.

FIG. 6 is a block diagram of a fixed network user subscription database of the communication system of FIG. 1 in accordance with an embodiment of the present invention.

FIG. 7 is a block diagram of a fixed network mobility and authentication device of the communication system of FIG. 1 in accordance with an embodiment of the present invention.

FIG. 8 is a flow chart illustrating a method for operating the communication system of FIG. 1 in providing subscriber information to a deployable user subscription database in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

One exemplary embodiment provides a method providing subscriber information to a deployable network including a deployable user subscription database. The method includes determining, by a controller, a location for the deployable network. The method further includes determining, by the controller, a geofence around the location. The method further includes identifying, by the controller, at least one mobile device that may be involved in responding to the incident. The method further includes determining, by the controller, authentication information required for the at least one mobile device to connect to the deployable network. The method further includes conveying, by the controller via a wireless data network, the authentication information to a deployable user subscription database.

Another embodiment provides an apparatus including a fixed network element. The fixed network element includes a network interface and a processor. The processor is configured to determine a location for a deployable network. The deployable network includes a deployable user subscription database. The processor is further configured to determine a geofence around the location. The processor is further configured to identify at least one mobile device that may be involved in responding to the incident. The processor is further configured to determine authentication information required for the at least one mobile device to connect to the deployable network. The processor is further configured to convey, via a wireless data network, the authentication information to the deployable user subscription database.

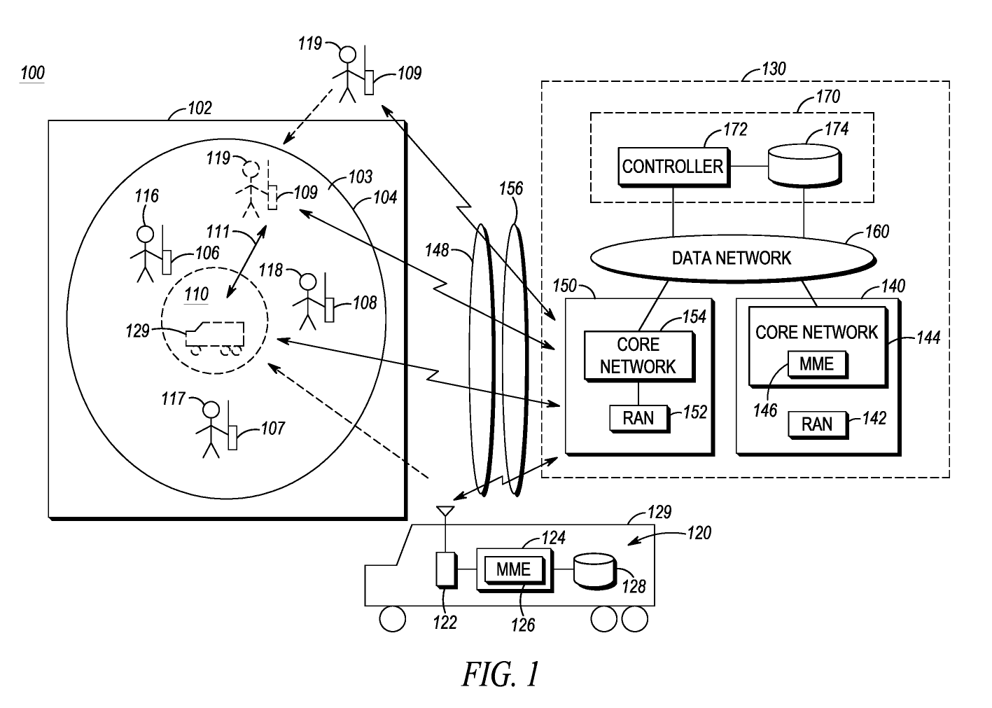

FIG. 1 is a block diagram of a wireless communication system 100 in accordance with some embodiments. A communication system 100 includes multiple wireless mobile devices 106-109. Each of the wireless mobile devices 106-109 may be, for example, a cellular telephone, a smart phone, a land mobile radio (LMR), a vehicle modem, a server mounted in vehicle, or a tablet, laptop, or body-worn computing device equipped for wireless communications, or a similar electronic communications device. In various radio technologies, a mobile device such as mobile devices 106-109 may be referred to as a user equipment (UE), a subscriber station (SS), an access terminal (AT), a mobile station (MS), or the like. Each mobile device 106-109 includes one or more application layer clients which communicate with corresponding elements of a local agency 170.

100171 Communication system 100 further includes a deployable network 120 and a fixed network, or infrastructure, 130. The fixed network 130 includes a first, broadband wireless network 140 and a second, narrowband wireless network 150 that are each in communication with a local agency 170 via a data network 160, for example, the Internet or a private enterprise or agency network. The local agency 170 includes one or more fixed network elements, including an infrastructure controller 172, such as a computer aided dispatch (CAD) controller and/or a public safety answering point (PSAP) that may be manned by a system operator, and a fixed network user subscription database 174, such as a home subscriber server (HSS). Any individual component of the fixed network 130 may be refered to as a fixed network element.

As is known in the art, a PSAP is a call center responsible for answering emergency calls, for example, calls to emergency telephone numbers for emergency responders such as police, firefighting, and emergency medical/ambulance services. Typically, a PSAP includes a computer-aided dispatch (CAD) system staffed by trained operators that are responsible for handling emergency calls and dispatching emergency responders to an incident scene. Most PSAPs further include the capability of determining a location of an originator of the call, such as a caller location for a landline call or a location of a cellular phone call, known as E911 Phase 1 (cell tower used by a caller) and E911 Phase 2 (latitude and longitude of a caller to within 300 meters). The CAD system includes a user display screen that, in response to an emergency call, displays a real-time, on-screen E911 street map that highlights the caller's location and that further depicts nearest available emergency responders and/or emergency response vehicles and other relevant information, such as fire hydrants, hazardous materials, and/or other data maintained by a city. PSAPs also provide broadcast services, where outgoing voice and data can be broadcast to multiple mobile phones/emergency responders/emergency response vehicles in order to alert the emergency responders and emergency response vehicles to a local emergency incident.

The fixed network user subscription database 174 maintains user-related and subscription-related information, for example, authentication and access control information that enables the fixed network 130 to successfully complete network entry authentication of mobile devices 106-109, such as authentication keys, mobile device identifiers, and authentication algorithms.

The broadband wireless network 140 comprises a broadband radio access network (RAN) 142 in communication with a broadband core network 144, such as an evolved packet core (EPC) of an LTE network, and includes a mobility and authentication device 146, such as a mobility management entity (MME). The mobility and authentication device 146 keeps track of the current location of all subscribers and their mobile devices, including a state of the mobile devices. The mobility and authentication device 146 also authenticates users and user devices by interacting with the fixed network user subscription database 174, such as a home subscriber server (HSS), and for generation and allocation of temporary identities or identifiers to mobile devices served by the mobility and location database.

The broadband radio access network 142 includes a broadband access node (not shown), such as a Node B or an eNodeB, that provides wireless communications services to broadband mobile devices residing in a coverage area of the broadband access node via a broadband air interface 148 and a first, broadband wireless protocol, such as the Third Generation Partnership Protocol (3GPP) LTE communications protocol. Broadband systems typically support high-bit-rate digital transmission of data streams, including real-time video.

The narrowband wireless network 150 comprises a narrowband radio access network (RAN) 152 in communication with a narrowband core network 154, which in turn is in communication with a narrowband call controller (not shown), for example, a site controller, a zone controller, or any other infrastructure device that performs call processing and allocates channels/resources for group calls. The narrowband RAN 152 includes a narrowband access node (not shown), such as a base station, that provides wireless communications services to narrowband mobile devices residing in a coverage area of the narrowband access node via a narrowband air interface 156 and a second, narrowband wireless protocol, such as a Project 25 (P25) wireless protocol, a land mobile radio (LMR) wireless protocol, or a terrestrial trunked radio (TETRA) wireless protocol. In some embodiments, the narrowband wireless network 150 is a land mobile radio network.

Each of the air interfaces 148 and 156 includes an uplink and a downlink, which uplinks and downlinks each include multiple traffic channels and multiple signaling channels. By way of example, the mobility and authentication device 146 is illustrated residing in the broadband core network 144. In alternative embodiments, the mobility and authentication device 146 may reside in the local agency 170 or may be external to, and accessible by, each of the broadband wireless network 140 and the local agency 170.

A public safety organization may use a specialized voice communication system that employs, for example, the narrowband wireless network 150 and a narrowband wireless protocol that typically supports low-bit-rate digital or analog transmission of audio and/or data streams. Likewise, the same public safety organization may also may use a broadband communication system that employs, for example, the broadband wireless network 140 and a broadband wireless protocol that supports data applications.

The deployable network 120 is a standalone broadband system, such as an LIE communication system, which is not connected to the fixed network 130 during a period when the deployable network is activated. Similar to the fixed network 130, and in particular the broadband wireless network 140, the deployable network 120 includes a deployable radio access network (RAN) 122 in communication with a deployable core network 124, such as an EPC, which deployable core network is, in turn, in communication with a deployable network user subscription database 128, such as a deployable HSS. The deployable network 120 may be located in, for example, a truck or a command vehicle 129 that has been dispatched to, and is in transit to, an incident scene 102. When the deployable network 120 arrives at the incident scene 102, the deployable network 120 establishes an incident area network (IAN) 103, which provides wireless communication services to responders at the incident area (also refered to herein as an “incident scene”) via the deployable RAN 122. The IAN 103 can be operated using any suitable WLAN protocol or mesh network protocol, such as IEEE 802.11 and variants thereof (e.g., “Wi-Fi”), LTE, WiMAX (IEEE 802.16e), and the like.

The deployable RAN 122 is a multi-mode RAN that is capable of wirelessly communicating with each of the narrowband wireless network 150 and the broadband wireless network 140. In some embodiments, the deployable RAN 122 includes a narrowband mobile base stated or an narrowband modem. In other embodiments, the deployable RAN 122 may include multiple portable base stations, wherein a first base station of the multiple portable base stations is a narrowband base station and a second base station of the multiple portable base stations is a broadband base station. By way of another example, the deployable RAN 122 may include a base station having multiple wireless transceivers, wherein a first transceiver of the multiple transceivers is a narrowband transceiver and a second transceiver of the multiple transceivers is a broadband transceiver. The deployable core network 124 handles data traffic for the deployable radio access network (RAN) 122, which forwards user data and signaling between the deployable core network 124 and the mobile devices 106-109 operating on the deployable network 120.

The deployable network 120, and in particular the deployable core network 124, further includes a deployable mobility and authentication device 126 (e.g., an MME), which provides end-user mobility and authentication functions. The deployable network user subscription database 128 maintains user-related and subscription-related information to enable the deployable network 120 to successfully complete network entry authentication of the mobile devices 106-109. The term ‘deployable network elements’, as used herein, may refer to one or more elements of deployable network 120 (the deployable RAN 122, the deployable core network 124, the mobility and authentication device 126, and the deployable network user subscription database 128).

For ease of description, the communication system 100 illustrated in FIG. 1 includes the listed components and subcomponents in the quantites illustrated and noted herein. Alternative embodiments may include more or fewer of each of these components, may combine some components, or may include other alternative components.

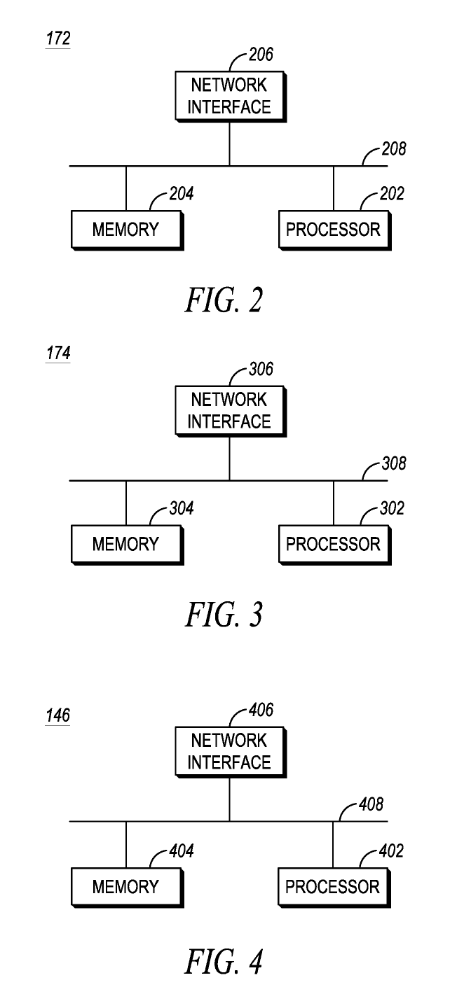

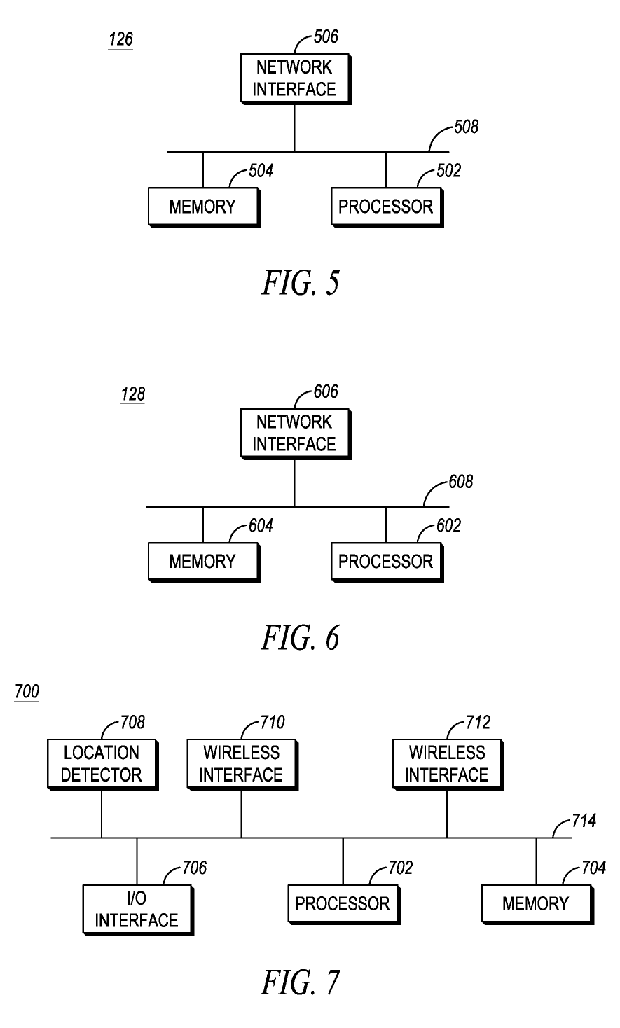

Referring now to FIGS. 2-6, block diagrams are provided of the infrastructure controller 172, the fixed network user subscription database 174, the fixed network mobility and authentication device 146, the deployable mobility and authentication device 126, and the deployable network user subscription database 128 in accordance with some embodiments of the present invention. Each of the infrastructure controller 172, fixed network user subscription database 174, fixed network mobility and authentication device 146, deployable mobility and authentication device 126, and deployable network user subscription database 128 includes a respective processor 202, 302, 402, 502, and 602, such as one or more elecotronic microprocessors, microcontrollers, digital signal processors (DSPs), combinations thereof or such other devices known to those having ordinary skill in the art. Each of the deployable mobility and authentication device 126, deployable network user subscription database 128, infrastructure controller 172, fixed network user subscription database 174, and fixed network mobility and authentication device 146 further includes a respective at least one memory device 204, 304, 404, 504, and 604, such as random access memory (RAM), dynamic random access memory (DRAM), and/or read only memory (ROM) or equivalents thereof, that is in communication with a corresponding processor 202, 302, 402, 502, and 602 via a corresponding local interface 208, 308, 408, 508, and 608. Each of the at least one memory devices 204, 304, 404, 504, and 604 stores data and programs that may be executed by the corresponding processor 202, 302, 402, 502, and 602 and that allows the deployable network elements to perform the functions necessary to operate in communication system 100.

Each of the infrastructure controller 172, fixed network user subscription database 174, fixed network mobility and authentication device 146, deployable mobility and authentication device 126, and deployable network user subscription database 128 further includes a respective one or more network interfaces 206, 306, 406, 506, and 606 that is in communication with a corresponding processor 202, 302, 402, 502, and 602 via a corresponding local interface 208, 308, 408, 508, and 608 and that provides for interfacing with other elements of communication system 100. For example, the network interfaces 206, 306, and 406 of the infrastructure controller 172, fixed network user subscription database 174, and fixed network mobility and authentication device 146 couple the controller, database, and network mobility and authentication device to other elements of fixed network, or the infrastructure, 130, such as to the data network 160, and via the data network to the broadband wireless network 140, narrowband wireless network 150, and local agency 170. The network interfaces 506 and 606 of the deployable mobility and authentication device 126 and the user subscription database 128 couple the deployable mobility and authentication device 126 and the user subscription database 28 to other elements of the deployable network 120, and via the deployable RAN 122 to each of the fixed network 130 and mobile devices 106-109 in a coverage area of the deployable RAN.

Each of the local interfaces 308, 408, 508, 608, and 714 can be, for example but not limited to, one or more buses or other wired or wireless connections, as is known in the art. Each of the local interfaces 308, 408, 508, 608, and 714 can have additional elements, which are omitted for simplicity, such as controllers, buffers (caches), drivers, repeaters, and receivers, among many others, to enable communications. Further, each of the local interfaces 308, 408, 508, 608, and 714 may include address, control, and/or data connections to enable appropriate communications among the aforementioned components.

For ease of description, each of the infrastructure controller 172, fixed network user subscription database 174, fixed network mobility and authentication device 146, deployable mobility and authentication device 126, and deployable network user subscription database 128 are illustrated with only one of each of the listed components. Alternative embodiments may include more or fewer of each of these components, may combine some components, or may include other alternative components.

The at least one memory device 304 of the fixed network user subscription database 174 further maintains authentication information (referred to collectively herein as “authentication information”) for each of the mobile devices 106-109 that enables the fixed network 130 to successfully complete network entry authentication of the mobile devices 106-109. For example, the authentication information may include one or more fixed network authentication keys for authenticating the mobile device to the local agency 170, such as an operator key (OP) for identifying the operator of the local agency 170, an authentication key/existing key (K) for authenticating the mobile device, and in cases where mutual authentication is utilized by a system operator using, for example, the Milenage AKA algorithm, an operator key (OPc) resulting from combining OP with K. The authentication information further includes a mobile device identifier, such as an International Mobile Subscriber Identity (IMSI), that uniquely identifies the mobile device in communication system 100. The fixed network user subscription database 174 may maintain multiple versions of the authentication and access control information for each mobile device, for example a current version and one or more previous versions. The versions may be identified by an associated version number, or by a time stamp that indicates when the information was last updated.

Additionally, in order to prevent the fixed network authentication keys from being publicly exposed when the fixed network user subscription database 174 conveys the authentication information to the deployable network 120, the at least one memory device 304 of fixed network user subscription database 174 maintains a key derivation algorithm for deriving deployable network authentication keys based on the fixed network authentication keys. When the fixed network user subscription database 174 conveys authentication and access control information to the deployable network 120, the fixed network user subscription database conveys the derived deployable network authentication keys and, therefore, the integrity of the fixed network authentication keys is maintained even if the conveyed keys are intercepted.

Referring now to FIG. 7, a block diagram of a mobile device 700, such as mobile devices 106-109, is provided in accordance with some embodiments. The mobile device 700 generally includes a processor 702, at least one memory device 704, one or more input/output (I/O) interfaces 706, a location detector 708, and one or more wireless interfaces 710, 712. It should be appreciated by those of ordinary skill in the art that FIG. 7 depicts the mobile device 700 in simplified manner, and a practical embodiment may include additional components and suitably configured processing logic to support known or conventional operating features that are not described in detail herein, and may include more or fewer of each of the listed components, may combine some components, or may include other alternative components. The components (702, 704, 706, 708, 710, 712) of mobile device 700 are communicatively coupled via a local interface 714. The local interface 714 can be, for example but not limited to, one or more buses or other wired or wireless connections, as is known in the art. The local interface 714 can have additional elements, which are omitted for simplicity, such as controllers, buffers (caches), drivers, repeaters, and receivers, among many others, to enable communications. Furthermore, the local interface 714 may include address, control, and/or data connections to enable appropriate communications among the aforementioned components.

The mobile device 700 operates under the control of processor 702, such as one or more microprocessors, microcontrollers, digital signal processors (DSPs), combinations thereof or such other devices known to those having ordinary skill in the art. The processor 702 operates the mobile device according to data and instructions stored in the at least one memory device 704, such as random access memory (RAM), dynamic random access memory (DRAM), and/or read only memory (ROM) or equivalents thereof, that stores data and instructions that may be executed by the corresponding processor so that the mobile device may perform the functions described herein.

The one or more I/O interfaces 706 may include user interfaces that allow a user to input information in, and receive information from, mobile device 700. For example, the user interfaces may include a keypad, a touch screen, a scroll ball, a scroll bar, buttons, bar code scanner, and the like. Further, the user interfaces may include a display device such as a liquid crystal display (LCD), touch screen, and the like for displaying system output. I/O interfaces 210 also can include, for example, a serial port, a parallel port, a small computer system interface (SCSI), an infrared (IR) interface, a universal serial bus (USB) interface, and the like for communicating with, or coupling to, an external device. The one or more wireless interfaces 710, 212 facilitate an exchange of wireless communications with a wireless access network, such as access networks 122, 142, and 152. For example, the one or more wireless interfaces 710, 712 may include transceivers for wireless wide area communications, such as a wireless area network (WAN), and/or for wireless local area network (WLAN) communications.

The location detector 708 determines a geographical location of mobile device 700. The location detector 708 may be, for example, a GPS receiver and/or may include circuitry, for example, one or more antennas and a microprocessor, such as being implemented by the processor 702, by which the mobile device 700 may receive signals from multiple base stations and determine its location based on the received signals, such as based on a time differences of arrival (TDOA) among such signals and/or triangulation. In still other exemplary embodiments of the location detector 708, the mobile device 700 may transmit, via the one or more wireless interfaces 710, 712, a signal to each of multiple base stations, which may in turn determine a location of the mobile device based on time differences of arrival (TDOA) among the signals received at each such base station and/or triangulation and then one or more of the base stations may transmit the determined location back to the mobile device. Based on the signals received from the one or more base stations, the location detector 708 determines the location of the mobile device 700.

The one or more wireless interfaces 710, 712 facilitate wireless communications with other mobile devices and/or with access networks 122, 142, and 152. For example, the one or more wireless interfaces 710, 712 may include a first, short-range wireless interface 710 for short-range communications, such as a Bluetooth transceiver and antenna and/or a WLAN transceiver and antenna. Furthermore, the one or more wireless interfaces 710, 712 may include a second, longer range wireless interface 712, such as a wireless area network (WAN) transceiver and antenna.

The data and instructions maintained by at least one memory device 704 include software programs that include an ordered listing of executable instructions for implementing logical functions. For example, the software in at least one memory device 704 includes a suitable operating system and programs. The operating system essentially controls the execution of other computer programs, and provides scheduling, input-output control, file and data management, memory management, and communication control and related service. The programs may include various applications, add-ons, and the like configured to provide user functionality for mobile device 700.

Further, in order to authenticate with, and access, the fixed network 130 and the local agency 170, the mobile device 700 maintains, in at least one memory device 704, the fixed network authentication information, that is, the one or more fixed network authentication keys for authenticating the mobile device 700 to the local agency 170, such as the operator key (OP), the authentication key/existing key (K), and in cases where mutual authentication is utilized by a system operator using, for example, the Milenage AKA algorithm, the operator key (OPc) resulting from combining OP with K. The at least one memory device 704 further maintains the mobile device identifier, such as an International Mobile Subscriber Identity (IMSI), that uniquely identifies the mobile device 700 in the communication system 100, and a deployable network list that includes a list of deployable network identifiers, such as a PLMN ID (Public Land Mobile Network Identifier), for each deployable network, such as the deployable network 120. Additionally, in order to authenticate with, and access, deployable networks such as the deployable network 120, at least one memory device 704 maintains the same key derivation algorithm as fixed network 130, which key derivation algorithm is used by the mobile device to derive deployable network authentication keys based on the fixed network authentication keys.

When an incident occurs that may require emergency services, the deployable network 120 may be dispatched to the incident scene 102 to provide temporary broadband wireless coverage. Upon arriving at the incident scene 102, the deployable network 120 may set up ad-hoc an incident area network (IAN), such as IAN 103. Upon arriving at the IAN 103, the deployable network 120 may not be connected to the fixed network 130. However, to maintain secure communications among the first responders, the deployable network 120 must be able to successfully complete IAN entry authentication of the first responders' mobile devices 106-109 even though there is no connectivity to the fixed network 130.

To facilitate the deployable network's 120 ability to successfully complete IAN entry authentication of the first responders' mobile devices 106-109, the communication system 100 provides updated authentication information to the deployable network for the mobile devices identified as involved in responding to the incident (that is, the mobile devices 106-108), prior to the deployable network's arrival at the incident scene. As the deployable network 120 may be outside of the coverage of the broadband wireless network 140 when at the incident scene 102, the communication system 100 provides the updated authentication information to the deployable network 120 via second, narrowband wireless network 150 and the second, narrowband wireless protocol. Furthermore, the communication system 100 provides for an updating of the authentication information for late arriving users/mobile devices, such as user 119/mobile device 109, via the second, narrowband wireless network 150 and the second, narrowband wireless protocol, in response to receiving an indication of the late arriving user 119/mobile device 109 heading towards, or arriving at, the incident scene.

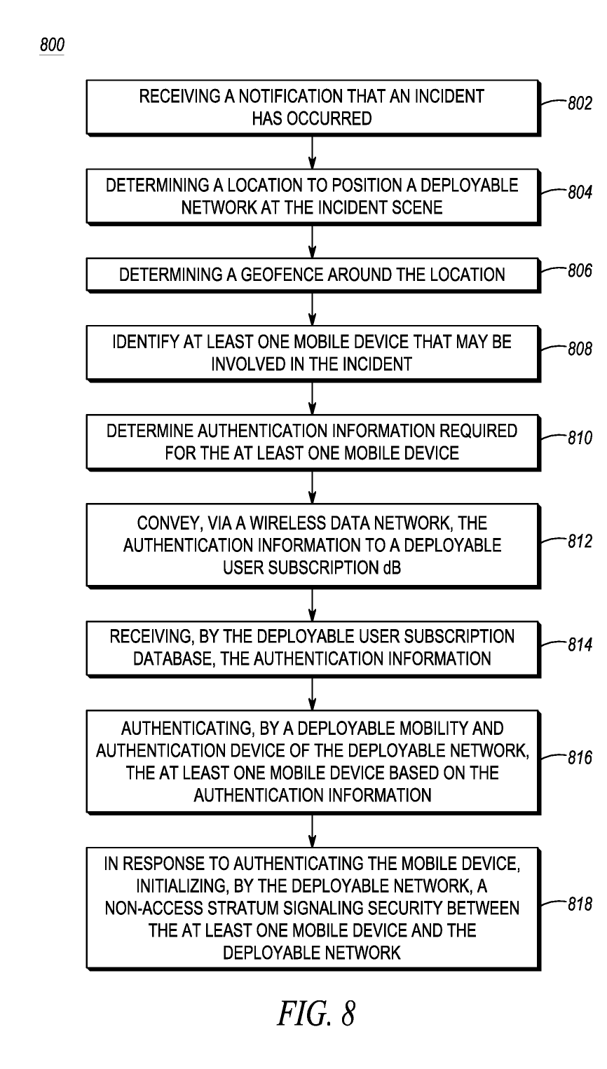

FIG. 8 illustrates an exemplary method 800 for controlling the communication system 100. At block 802, the local agency 170, and in particular infrastructure controller 172, receives notifation that an incident has occurred. For example, the incident may be reported by any one of various incident alarm devices as known in the art, the locations of which are pre-configured into the infrastructure controller 172 or into a database accessible by the infrastructure controller 172. By way of another example, the incident may be reported in an emergency call by a wireline communication device or a mobile device whose location is determinable via known techniques by a service provider that provides communication services to the wireline communication device or mobile device, which location is provided by the service provider when forwarding the emergency call to the local agency 170.

The incident occurs at a given geographic location, that is, the incident scene 102. In some embodiments, in response to receiving the notification of the incident, the infrastructure controller 172 automatically assigns a deployable network 120 to the incident scene 102. At block 804, the infrastructure controller 172 determines a location of the incident scene 102 and a location 110 at which to position the deployable network 120 at the incident scene. For example, the location 110 at the incident scene 102 may be selected based on a location of a caller reporting the incident. That is, as noted above, most PSAPs include the capability of determining a location of an originator of the call, such as a caller location for a landline call or a location of a cellular phone call, known as E911 Phase 1 (cell tower used by a caller) and E911 Phase 2 (latitude and longitude of a caller to within 300 meters). An associated CAD system includes a user display screen that, in response to an emergency call, displays a real-time, on-screen E911 street map that highlights the caller's location and that further depicts nearest available emergency responders and/or emergency response vehicles and other relevant information, such as fire hydrants, hazardous materials, and/or other data maintained by a city. By way of another example, the location 110 may be determined based on the locations of such emergency responders and/or emergency response vehicles. For example, the infrastructure controller 172 may determine an optimal location for a deployable network based on locations of various mobile devices (e.g., carried by emergency response personnel or vehicle-mounted devices), wherein a value (“mass”) is determined for each mobile device based on the applications running on the mobile device and a center of mass then is determined for the applications running on the mobile devices and the devices' locations, which center of mass serves as a location for the deployable network.

In response to determining the location 110, at block 806, the infrastructure controller 172 further determines a geofence 104 around the location 110. At block 808, the infrastructure controller 172 identifies, for example by reference to the mobility and authentication device 146, at least one mobile device (for example, one or more of the mobile devices 106-109) that may be involved with the incident (that is, devices whose users may be involved in responding to the incident). In some embodiments, the infrastructure controller 172 identifies the one or more mobile devices that may be involved with the incident based on location updates received from the one or more mobile devices. For example, when the location updates from one or more of the mobile devices 106-108 indicate that they are located within the geofence 104, infrastructure controller 172 identifies that the one or more of the mobile devices 106-108 may be involved with the incident because of their proximity to the incident scene 102. In another example, the mobile device 109 is outside the geofence 104, but the infrastructure controller 172 identifies that it may be involved with the incident because location updates indicate that the mobile device 109 is moving toward the geofence 104. In some embodiments, other attributes of a mobile device may be used to identify that the mobile device a may be involved with the incident. For example, the mobile device may be assigned to a user whose role suggests that he or she will likely respond (for example, a public safety supervisor).

At block 810, with reference to the fixed network user subscription database 174, the infrastructure controller 172 determines the authentication and access control information required for the one or more mobile devices identified at block 808 (for example, the mobile devices 106-109). At block 812, the infrastructure controller 172 conveys (e.g., pushes) the authentication and access control information to the deployable network 120, via a wireless data network, to the deployable network 120. For example, the infrastructure controller 172 may convey the authentication and access control information via the narrowband wireless network 150. As a broadband channel typically includes greater bandwidth than a narrowband channel, the infrastructure controller 172 may obtain an assignment of multiple wireless narrowband channels in the narrowband air interface 156 from the narrowband wireless network 150 and then aggregate the multiple wireless narrowband channels for conveyance of the AASC information. Further, in order to facilitate the conveyance of broadband control data over a narrowband wireless channel, each of the deployable network RAN 122 and the narrowband radio access network RAN 152 may include an interworking function that embeds broadband control data in a narrowband signal for transmission via a narrowband air interface and that extracts broadband control data from a narrowband signal that is received via a narrowband air interface. In an alternative embodiment, the the infrastructure controller 172 may convey the authentication and access control information via a wireless wide area network.

Regardless of the type of wireless data network used, in some embodiments, the infrastructure controller 172 conveys the authentication and access control information prior to the deployable network arriving at incident scene 102. For example, the infrastructure controller 172 may convey the authentication and access control information to deployable network 120 when the deployable network is assigned to the incident scene 102 or the infrastructure controller 172 may convey the authentication and access control information to the deployable network 120 when the deployable network is in transit to the incident scene. In alternative embodiments, the infrastructure controller 172 conveys the authentication and access control information when the deployable network 120 is deployed at the location 110.

In response to receiving the authentication and access control information for the mobile devices 106-109 identified at block 808, the deployable network 120 routes the authentication and access control information information to the deployable user subscription database 128, which stores the authentication and access control information information in the at least one memory device 404.

In some embodiments, the deployable network 120 is pre-configured with authentication and access control information for the mobile devices 106-109, that is, it may be provisioned with authentication and access control information for each of mobile devices 106-109 prior to being assigned to the incident scene 102. In such an embodiment, the authentication and access control information conveyed by the infrastructure controller 172 to the deployable network 120 may be one or more updates to the authentication and access control information maintained by the deployable network 120. That is, the infrastructure controller 172 may only convey to the deployable network 120 changes in the authentication and access control information already maintained by the deployable network 120.

When the deployable network 120 arrives at the incident scene 102, the deployable network 120, and in particular the mobility and authentication device 126, authenticates, at block 816, each of the identified mobile devices 106-108 by reference to the authentication and access control information stored in the deployable user subscription database 128 and in accordance with known authentication techniques.

At block 816, in response to successfully authenticating one or more of the mobile devices 106-109, the deployable network 120 permits the authenticated mobile devices access to services and applications (for example, Push-to-Talk (PTT) services and video sharing) that may be provided by the deployable network 120.

In some embodiments, in performing the authentication at block 816, when deployable network 120 arrives at incident scene 102, the deployable network may announce its presence, for example, by broadcasting a control message that includes an identifier of the deployable network, such as a PLMN ID. For example, the control message may be an overhead message that includes system information bits (SIBs) that include the identifier of the deployable network. In response to receiving the control message, each of the mobile devices within the geofence, such as mobile devices 106-108, determines whether the mobile device recognizes the deployable network identifier, for example, whether the deployable network identifier matches a network identifier included in the list of network identifiers maintained by the mobile device. In response to determining that it recognizes the deployable network identifier, each of mobile devices 106-108 may convey a request to attach to deployable network 120, which attachment request includes an identifier of the mobile device. Further, a mobile device that receives the control message but may be outside of the geofence, such as mobile device 109, also may convey a request to attach to deployable network 120 in response to recognizing the deployable network identifier.

In response to receiving the attachment requests from mobile devices 106-109, the deployable network 120 routes the attachment requests to mobility and authentication device 126. Mobility and authentication device 126 then retrieves, from user subscription database 128, available authentication information for each of the mobile devices 106-109 requesting to attach. For example, mobility and authentication device 126 may convey, to user subscription database 128, a request for authentication information for each of the mobile devices 106-109, which authentication requests each include an identifier of the mobile device. In response to receiving the request for authentication information, user subscription database 128 uses the identifier of each mobile device and one or more keys that are shared by mobile device and the user subscription database to determine authentication information for that mobile device. For example, user subscription database 128 may use each mobile device's identifier and the shared keys to calculate authentication information, for example an authentication vector comprising multiple authentication parameters, for that mobile device and return the authentication information to mobility and authentication device 126, indicating that the user subscription database is requesting that the mobile device use its security algorithms in order to authenticate.

The mobility and authentication device 126 then conveys an authentication request to each of mobile devices 106-109 that includes at least a portion of the authentication information, for example, one or more of the authentication parameters, determined for that mobile device. As each mobile device 106-109 has a same shared key as user subscription database 126, each mobile device can perform its own calculation of one or more of the received authentication parameters. If the authentication parameter(s) calculated by each mobile device 106-108 matches an authentication parameter received by the mobile device, then the mobile device determines that deployable network 120 is legitimate. In response to determining that deployable network 120 is legitimate, each mobile device 106-109 calculates a response value and conveys, to deployable network 120, an authentication response that includes the response value. Deployable network 120 routes the authentication responses received from each mobile device 106-109 to mobility and authentication device 126, which forwards the authentication responses with the response values to user subscription database 128. For each of mobile devices 106-109, if the response value received from the mobile device matches a corresponding response value calculated by user subscription database 128 for that mobile device, then the user subscription database authenticates the mobile device and so informs mobility and authentication device 126. In response to being informed that a mobile device 106-109 is authenticated, mobility and authentication device 126 then informs the mobile device that it has been authenticated and its attachment is accepted.

In some embodiments, in response to the authentication of one or more of the mobile devices 106-109, the deployable network 120 further may establish, at block 818, a secure user plane data connection between each of the authenticated mobile devices and the deployable network 120. For example, in the event that each of broadband wireless network 140 and deployable network 120 is an LTE network, in response to being informed that one or more mobile devices 106-109 is authenticated, the mobility and authentication device 126 initializes Non-Access Stratum (NAS) signaling security between the mobile device and the mobility and authentication device 126. NAS signaling security is described, for example, in 3GPP (Third Generation Partnership Project) Technical Specification (TS) 24.301.

The embodiments of the present invention preferably are implemented within each of mobile devices 106-109 and network elements 128, 172, and 174, and more particularly with or in software programs and instructions stored in the at least one memory devices 404, 604, 504 and executed by the processors 402, 602, 502 of the mobile devices and network elements. However, one of ordinary skill in the art realizes that the embodiments of the present invention alternatively may be implemented in hardware, for example, integrated circuits (ICs), application specific integrated circuits (ASICs), and the like, such as ASICs implemented in one or more of mobile devices 106-109 and network elements 128, 172, and 174, and all references to ‘means for’ herein may refer to any such implementation of the present invention. Based on the present disclosure, one skilled in the art will be readily capable of producing and implementing such software and/or hardware without undo experimentation.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes”, “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed. Also, the expressions “air interface” and “wireless link” are intended to be used interchangeably herein.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage element or medium having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for providing subscriber information to a deployable network including a deployable user subscription database, the method comprising:
determining, by a controller, a location for the deployable network;
determining, by the controller, a geofence around the location;
identifying, by the controller, at least one mobile device that may be involved in responding to the incident;
determining, by the controller, authentication information required for the at least one mobile device to connect to the deployable network; and
conveying, by the controller via a wireless data network, the authentication information to a deployable user subscription database.

2. The method of claim 1, wherein identifying the at least one mobile device includes determining that the at least one mobile device is located within the geofence based on a location update received from the at least one mobile device.

3. The method of claim 1, wherein identifying the at least one mobile device includes determining that the at least one mobile device is in transit to the location based on a location update received from the at least one mobile device.

4. The method of claim 1, wherein conveying the authentication information to the deployable user subscription database includes conveying the authentication information to the deployable user subscription database while the deployable network is in transit to the location.

5. The method of claim 1, wherein conveying the authentication information to the deployable user subscription database includes conveying one or more updates to the authentication information maintained by the deployable user subscription database.

6. The method of claim 1, wherein conveying the authentication information via the wireless data network includes conveying the authentication information via a land mobile radio network or a wireless wide area network.

7. The method of claim 1, further comprising:
receiving, by the deployable user subscription database, the authentication information; and
authenticating, by a deployable mobility and authentication device of the deployable network, the at least one mobile device based on the authentication information.

8. The method of claim 7, further comprising:
in response to authenticating the at least one mobile device, initializing, by the deployable network, a secure user plane data connection between the at least one mobile device and the deployable network.

9. The method of claim 8, wherein initializing the secure user plane data connection between the at least one mobile device and the deployable network includes initializing non-access stratum signaling security.

10. An apparatus comprising:
a fixed network element including
a network interface; and
a processor configured to
determine a location for a deployable network, wherein the deployable network includes a deployable user subscription database;
determine a geofence around the location;
identify at least one mobile device that may be involved in responding to the incident;
determine authentication information required for the at least one mobile device to connect to the deployable network; and
convey, via a wireless data network, the authentication information to the deployable user subscription database.

11. The apparatus of claim 10, wherein the processor is further configured to identify the at least one mobile device by determining that the at least one mobile device is located within the geofence based on a location update received from the at least one mobile device.

12. The apparatus of claim 10, wherein the processor is further configured to identify the at least one mobile device by determining that the at least one mobile device is in transit to the location based on a location update received from the at least one mobile device.

13. The apparatus of claim 10, wherein the processor is further configured to convey the authentication information to the deployable user subscription database by conveying the authentication information to the deployable user subscription database while the deployable network is in transit to the location.

14. The apparatus of claim 10, wherein the processor is further configured to convey the authentication information to the deployable user subscription database by conveying one or more updates to the authentication information maintained by the deployable network.

15. The apparatus of claim 10, wherein the processor is further configured to convey the authentication information via the wireless data network by conveying the authentication information via a land mobile radio network or a wireless wide area network.

16. The apparatus of claim 10, further comprising:
the deployable network;
wherein the deployable network is configured to
receive the authentication information; and
authenticate the at least one mobile device based on the authentication information.

17. The apparatus of claim 16, wherein the deployable network is further configured to, in response to authenticating the at least one mobile device, initialize a secure user plane data connection between the at least one mobile device and the deployable network.

18. The apparatus of claim 17, wherein the deployable network is further configured to activate the secure user plane data connection between the between the at least one mobile device and the deployable network by initializing non-access stratum signaling security.

19. The apparatus of claim 10, wherein the fixed network element includes at least one selected from a group consisting of an infrastructure controller, a mobility and authentication device, and a user subscription database.

20. The apparatus of claim 19, wherein the deployable network includes a long term evolution communication system, the mobility and authentication device is a mobility management entity, and the user subscription database is a home subscriber server.
